(19) United States
(12) Patent Application Publication
(10) Pub. No.: US 2022/0416347 A1
(43) Pub. Date: Dec. 29, 2022

(54) SWAPPABLE BATTERY PACK

(71) Applicant: GRABTAXI HOLDINGS PTE. LTD., Singapore (SG)

(72) Inventors: Kang YAN, Beijing (CN); Yanhua LV, Beijing (CN); Xihu WU, Beijing (CN); He ZHANG, Beijing (CN)

(21) Appl. No.: 17/619,942

(22) PCT Filed: Mar. 18, 2020
(86) PCT No.: PCT/SG2020/050142

§ 371 Date: Dec. 16, 2021

(51) Int. Cl. H01M 50/244; H01M 10/48; H01M 50/213; H01M 50/24; H01M 50/224; H01M 50/271; H01M 50/503

(52) U.S. Cl. CPC H01M 50/244; H01M 10/488; H01M 50/213; H01M 50/24; H01M 50/224; H01M 50/271; H01M 50/503; H01M 50/249

(57) ABSTRACT

Aspects concern a battery pack for mounting on a vehicle. The battery pack may comprise an elongated cell rack comprising one or more battery cells arranged therein. The battery pack may comprise a tubular battery case at least partially surrounding the elongated cell rack. The battery pack may comprise a top seal cover sealing a top portion of the elongated cell rack. The battery pack may comprise a bottom seal cover arranged at a bottom portion of the elongated cell rack. The battery pack may comprise a female pin receptacle arranged on the bottom seal cover at the bottom portion of the elongated cell rack.

### TECHNICAL FIELD

Various aspects of this disclosure relate to a battery pack for mounting on a vehicle. In particular, various embodiments generally relate to a battery pack that is swappable for being used in a vehicle sharing system.

### BACKGROUND

Vehicles, such as electric scooters, may include a battery pack. For avoiding downtime during operation due to charging of the battery pack, it is desired to have a swappable battery pack which enables high efficiency for fleet operation. The following problems arise with swappable battery packs:
Big physical dimensions and heavy weight of the battery pack complicating swapping;
Lower waterproof level of a swappable battery pack due to frequent disconnection;
Insufficient strength of battery case, causing deformations;
Lack of a clear battery capacity indicator within the structure design.

Therefore, there is a need to solve above mentioned problems.

### SUMMARY

Various embodiments concern a battery pack for mounting on a vehicle. The battery pack may comprise an elongated cell rack comprising one or more battery cells arranged therein. The battery pack may comprise a tubular battery case at least partially surrounding the elongated cell rack. The battery pack may comprise a top seal cover sealing a top portion of the elongated cell rack. The battery pack may comprise a bottom seal cover arranged at a bottom portion of the elongated cell rack. The battery pack may comprise a female pin receptacle arranged on the bottom seal cover at the bottom portion of the elongated cell rack.

According to various embodiments, the battery pack may further comprise a top cover forming a first waterproof seal at the top portion of the elongated cell rack.

According to various embodiments, the battery pack may further comprise a bottom cover arranged on the female pin receptacle. The bottom cover may be engageable with the female pin receptacle and the bottom seal cover to render the bottom portion of the elongated cell rack accessible for insertion of at least one male pin.

According to various embodiments, the battery pack may further comprise a sealing gasket ring positionable on the bottom cover.

According to various embodiments, the battery pack may further comprise a battery capacity indicator. The battery capacity indicator may be positionable at the top portion of the elongated cell rack.

According to various embodiments, the battery pack may further comprise a first lubricating member fixedly surrounding the bottom portion of the elongated cell rack. The battery pack may further comprise a second lubricating member fixedly surrounding the top portion of the elongated cell rack. One or each of the first lubricating member and the second lubricating member may be in the form of a sleeve. One or each of the first lubricating member and the second lubricating member may be made of self-lubricating material.

According to various embodiments, the battery pack may further comprise a pivotable pull-ring at the top portion of the elongated cell rack.

According to various embodiments, the tubular battery case may comprise aluminum. The tubular battery case may comprise or may consist of a one-piece tubular segment.

Various embodiments concern a set comprising a battery pack for mounting on a vehicle. The set may comprise the battery pack as described above. The set may further comprise a connector comprising a front end surface and at least one male pin protruding from the front end surface. The at least one male pin may be configured to cooperate with the female pin receptacle to provide an electrical connection. The at least one male pin may have a complementary shape to the female pin receptacle of the battery pack.

According to various embodiments, the battery pack of the set may further comprise a bottom cover arranged on the female pin receptacle. The bottom cover may be engageable with the female pin receptacle and the bottom seal cover to render the bottom portion of the elongated cell rack accessible for insertion of the at least one male pin. The bottom cover may render the bottom portion to be engageable with the front end surface to form a second waterproof seal.

According to various embodiments, the battery pack of the set may further comprise a sealing gasket ring positionable on the bottom cover, to form a third waterproof seal with the front end surface by being pressed between the front end surface and the female pin receptacle.

Various embodiments concern a vehicle comprising the battery pack as described above. The vehicle may be an electric scooter. The vehicle may further comprise a receptacle. The receptacle may be configured to receive the battery pack. The receptacle may further comprise at least one male pin protruding from a front end surface.

Various embodiments concern a method of swapping a first battery pack with a second battery pack in a vehicle. Each of the first battery pack and the second battery pack may comprise features as described herein. The method may comprise a first step of retrieving the first battery pack from a receptacle of the vehicle. This step may be carried out by disconnecting the female pin receptacle of the first battery pack from at least one male pin protruding from a front end surface of the receptacle. The method may comprise a second step of sliding the second battery pack into the receptacle of the vehicle. The method may comprise a third step of engaging the second battery pack with the vehicle. This step may be carried out by connecting the at least one male pin protruding from the front end surface of the receptacle with a female pin receptacle of the second battery pack.

Various embodiments concern a vehicle sharing system comprising the vehicle as described above.

According to various embodiments, the vehicle sharing system may further comprise a battery charging station configured to charge a battery pack removed from the vehicle.

### BRIEF DESCRIPTION OF THE DRAWINGS

The invention will be better understood with reference to the detailed description when considered in conjunction with the non-limiting examples and the accompanying drawings, in which:

FIG. 1 shows an exploded view of a battery pack for mounting on a vehicle, in accordance with various embodiments;

FIG. 2 shows a schematic representation of the battery pack, wherein a first lubricating member and a second lubricating member are attached, in accordance with various embodiments;

FIG. 3 shows a schematic representation of the battery pack, wherein the one or more battery cells are shown arranged in the elongated cell rack, in accordance with various embodiments;

FIG. 4 shows a schematic representation of the battery pack, in accordance with various embodiments;

FIGS. 5A and 5B show schematic representations of the battery pack engaging into a receptacle in two angular side views, one taken from an angle of the top portion (FIG. 5A), and the other taken from an angle of the bottom portion (FIG. 5B), in accordance with various embodiments;

FIG. 6 shows a schematic representation of the battery pack engaged with a receptacle in a side view, in accordance with various embodiments;

FIG. 7 shows a schematic representation of the battery pack, wherein a first lubricating member and a second lubricating member are shown in exploded view, in accordance with various embodiments;

FIG. 8 is a process flow chart illustrating the method steps of a method of swapping a first battery pack with a second battery pack in a vehicle.

### DETAILED DESCRIPTION

A battery pack is described herein solving the above mentioned problems. The battery pack(s) described herein may be water resistant and/or waterproof. The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

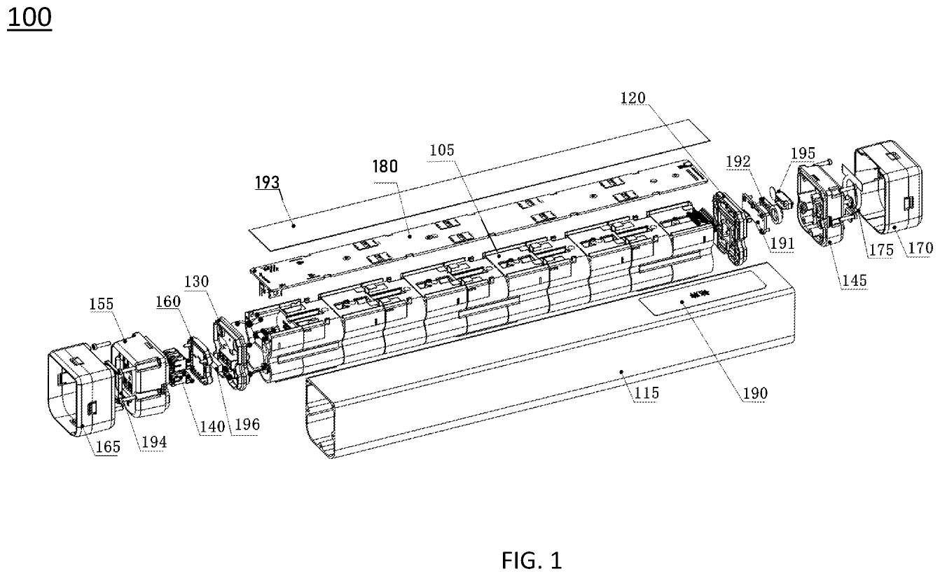

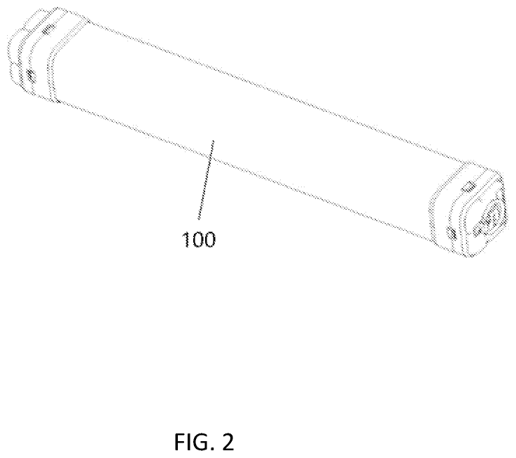

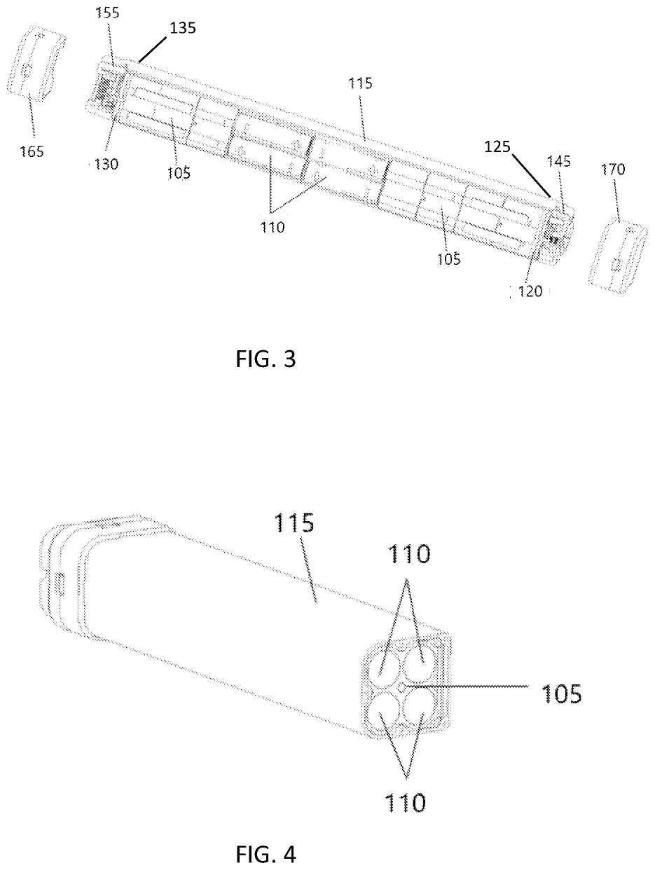

Several aspects of a battery pack for a vehicle will now be presented with reference to various apparatus and methods. FIG. 1 shows an exploded view of a battery pack 100 for mounting on a vehicle, in accordance with various embodiments. With reference to FIG. 2, the shape of the battery pack 100 may be an elongated object having two end portions. The two end portions may be substantially parallel to each other and define a middle section between each other. In other words, the two end portions may be opposing each other. The two end portions together with the middle section may form a cylinder, a prism or a prism with flattened edges. The cross-section of the battery pack 100 may thus substantially be a circle or a polygon. The polygon may have n sides, for example, 3 sides, 4 sides, etc. As shown in FIG. 2 and FIG. 3, in one example, the polygon has four sides, i.e., it is a rectangle. The edges of the polygon may be flattened edges. This design may facilitate the replacement of the battery pack 100 and may render the battery pack 100 suitable for centralized charging with a charging rack in a battery charging station 510. This design may additionally reduce the required space, and facilitate transportation. The sides may include recesses or protrusions, or alternatively, be substantially flat.

The battery pack 100 may comprise an elongated cell rack 105. The elongated cell rack 105 may form the main body of the battery pack 100. Hence, the general shape of the elongated cell rack 105 may be the same as that of the battery pack 100. The elongated cell rack 105 may thus be an elongated object having two end portions. The two end portions may be substantially parallel to each other and define a middle section between each other. In other words, the two end portions may be opposing each other. The two end portions together with the middle section may form a cylinder, a prism or a prism with flattened edges. The cross-section of the elongated cell rack 105 may thus substantially be a circle or a polygon. The edges of the polygon may be flattened edges. The polygon may have n sides, for example, 3 sides, 4 sides, 5 sides, etc. In one example, the polygon has four sides, i.e., it is a rectangle. In the example, the rectangle has flattened edges.

The two end portions of the elongated cell rack 105 may be termed herein as a top portion 125 and a bottom portion 135.

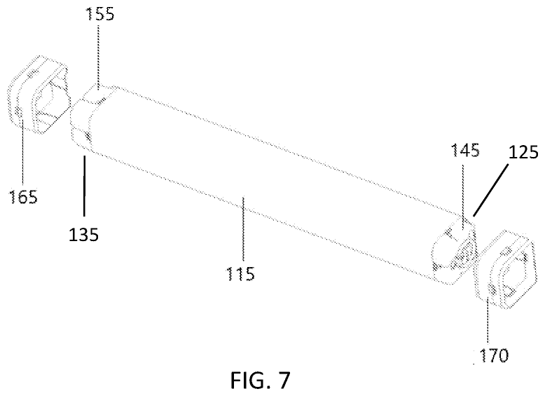

The distance between the top portion 125 and the bottom portion 135 may be the largest dimension of the battery pack 100 or the elongated cell rack 105 (FIG. 7).

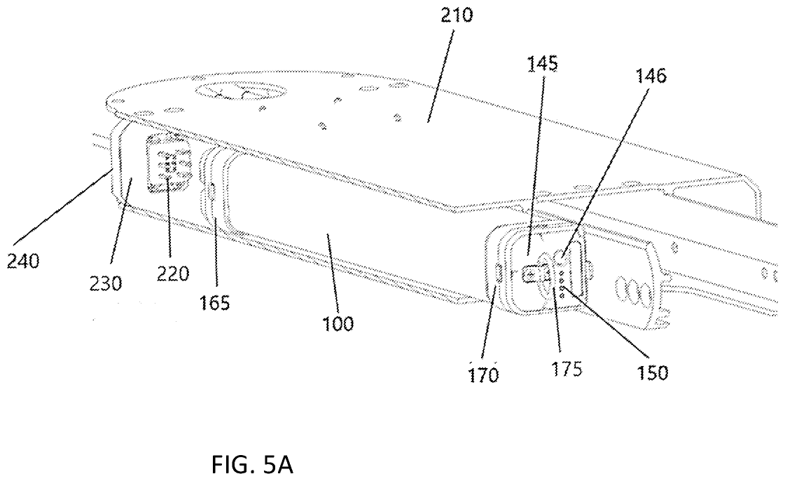

As shown in FIG. 3 and FIG. 4, one or more battery cells 110 may be arranged in the elongated cell rack 105. Hence, the elongated cell rack 105 may comprise the one or more battery cells 110. An external structure of the elongated cell rack 105 may form a unified item surrounding the one or more battery cells 110. This may ensure that the one or more battery cells 110 of the battery pack 100 do not become loose and may continue to function normally when the battery pack 100 is subjected to impact, collision, vibration, etc. Hence, the elongated cell rack 105 may provide resistance against shock and vibration, increasing the durability of the one or more battery cells 110.

The elongated cell rack 105 may be made of flame-retardant and heat-insulating material. The elongated cell rack 105 may comprise plastic. The elongated cell rack 105 may comprise a nickel plate.

The elongated cell rack 105 may be configured and have the function of connecting two or more of the battery cells 110 together and enable electrical connection between two or more of the battery cells 110. For example, two or more of the battery cells 110 may form a series connection, a parallel connection, or a series-parallel connection.

The one or more battery cells 110 in the battery pack 100 may be fixed in position by the elongated cell rack 105. The one or more battery cells 110 may be arranged in a direction parallel to the elongation of the cell rack 105. Each of the one or more battery cells 110 may have a longest dimension (e.g., battery cell length) which may be parallel to the longest dimension (e.g., elongated cell rack length) of the elongated cell rack 105.

The elongated cell rack 105 may have an interior structure to surround each of the one or more battery cells 110. The interior structure to surround each of the one or more battery cells 110 may be such that two adjacent batteries of the one or more battery cells 110 may be spaced apart by a distance selected between about 1.0 mm to about 5.0 mm, or by about 2.0 mm to about 4.0 mm, or by about 2.0 mm to about 3.0 mm, for example by about 2.5 mm. Advantageously, by maintaining a spacing between two adjacent batteries of the one or more battery cells 110, each of the one or more battery cells 110 is physically isolated, which improves safety of the battery pack 100. For example, if one of the one or more battery cells 110 fails, for example due to overheating or burning, this may not affect the remaining battery cells.

A battery pack 100 according to various embodiments may provide a structural solution to facilitate battery swapping for a vehicle 200, for example, for electric scooters. Compared with other solutions, the battery pack 100 may provide good protection of the one or more battery cells 110. With the elongated cell rack 105, a slim strip-type design is achieved, with reduced weight, which enables easy assembling and removing of the battery pack 100 from the vehicle 200.

A tubular battery case 115 may at least partially surround the elongated cell rack 105. The tubular battery case 115 may surround the elongated cell rack 105 along the middle section. The tubular battery case 115 may thus be an elongated object having two openings conforming to the top portion 125 and the bottom portion 135 of the elongated cell rack 105. The tubular battery case 115 may be hollow between the openings at the top portion 125 and the bottom portion 135 of the elongated cell rack 105, i.e., the two openings at the end surfaces may define a cavity between each other. The cavity may conform to the elongated cell rack 105. For example, when the elongated cell rack 105 delimited by the two end portions forms a rectangular prism, the tubular battery case 115 may have the shape of a rectangular tube. This ensures that the top portion 125 and the bottom portion 135 of the elongated cell rack 105 may be accessible, while the middle section of the elongated cell rack 105 may be surrounded by the tubular battery pack 115.

The two openings of the battery case 115 together with the cavity defined therein between may form an open cylinder, an open prism or an open prism with flattened edges. The cross-section of the tubular battery case 115 may thus substantially be a ring or a polygon frame. The edges of the polygon frame may be flattened edges. The polygon frame may have n sides, for example, 3 sides, 4 sides, 5 sides, etc. In one example, the polygon frame has four sides, i.e., it is a rectangular frame. The rectangular frame has flattened edges.

By having a cavity that conforms to the elongated cell rack 105, the tubular battery case 115 may cooperatively couple, or be cooperatively coupled, with the elongated cell rack 105. In particular, the elongated cell rack 105 may slide, or be positionable, into the tubular battery case 115. Advantageously, this may allow for easy insertion and/or holding of the elongated cell rack 105 into the tubular battery case 115. Further, by having a cavity that conforms to the elongated cell rack 105, this may ensure that the elongated cell rack 105 cannot be inserted incorrectly into the tubular battery case 115.

The tubular battery case 115 may comprise a metal. The metal may be selected from the group consisting of aluminum, iron, copper, chromium, zinc, titanium, manganese, and a combination thereof.

The metal may be an aluminum alloy. Hence, aluminum may be the main component of the tubular battery case material, and may be present in about more than 50 wt %, or in about more than 70 wt %, or in about more than 90 wt %. In one example, the tubular battery case material is 6061 aluminum alloy. Using a tubular battery case 115 comprising aluminum may result in a higher fixation of the elongated cell rack 105. The tubular battery case 115 may comprise or may consist of a one-piece tubular segment. In other words, the tubular battery case 115 may be a monolithic tubular battery case.

The top portion 125 of the elongated cell rack 105 may be sealed by a top seal cover 120. The top seal cover 120 may have a shape conforming to the top portion 125. For example, when the top portion 125 is shaped as a rectangle with flattened edges, the top seal cover 120 may have a shape conforming to the rectangle with flattened edges.

A bottom seal cover 130 may be arranged at a bottom portion 135 of the elongated cell rack 105. The bottom seal cover 130 may have a shape conforming to the bottom portion 135. For example, when the bottom portion 135 is shaped as a rectangle with flattened edges, the bottom seal cover 130 may have a shape conforming to the rectangle with flattened edges.

As shown in FIG. 3 and FIG. 4, the elongated cell rack 105 comprising the one or more battery cells 110 may be positionable in the cavity formed by the tubular battery case 115, the top seal cover 120 and the bottom seal cover 130. The gaps within the cavity may be evenly filled with an adhesive, for example, waterproof glue. This design may contribute to a first and a second waterproof seal for protection of the internal components of the battery pack 100, such that the battery pack 100 can achieve the waterproof and dust-proof IP67 level, thereby improving the safety and reliability of the battery pack 100.

The bottom seal cover 130, apart from the sealing the elongated cell rack 105, may specifically allow access for an electrical connection. For example, at least one wire may be protruding from the elongated cell rack 105, which may be guided through the bottom seal cover 130 and may meet with a female pin receptacle 140 on the other side of the bottom seal cover 130.

Hence, a female pin receptacle 140 may be arranged on the bottom seal cover 130 at the bottom portion 135 of the elongated cell rack 105. The at least one wire, for example, which may be guided through the bottom seal cover 130, may engage with the female pin receptacle 140 to provide the electrical connection between the female pin receptacle 140 and the elongated cell rack 105. On the other hand, the bottom seal cover 130 may seal the bottom portion 135 along those parts which do not provide access to the elongated cell rack 105.

The female pin receptacle 140 may be attached to a female pin holder 160, which may be disposed between the bottom seal cover 130 and the female pin receptacle 140. The female pin receptacle 140 may form the electrical connection between the elongated cell rack 105 and at least one male pin 220, when the battery pack 100 is mounted on the vehicle 200. The female pin receptacle 140 may comprise a design having recessive parts integrated on the battery pack 100. This may avoid damage and prevent short circuit. For example, by not having exposed pins on the battery pack 100 which could be bent and/or connected to each other, thereby result in a short circuit, enhanced safety is provided.

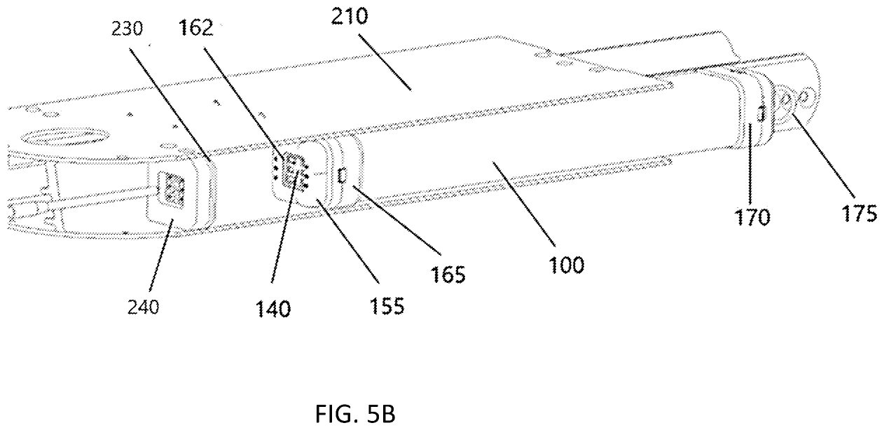

As shown in FIG. 5A and FIG. 5B, the vehicle 200 may comprise a receptacle 210, configured to receive the battery pack 100. The receptacle 210 may comprise a protruding part, which may be the at least one male pin 220. The at least one male pin 220 may be positionable on a front end surface 230 of the receptacle 210. The at least one male pin 220 may be protruding from at least one male pin holder 240. When the battery pack 100 is mounted on the vehicle 200, the battery pack 100 may be abutted against the front end surface 230 and connected by a plug-in type connection, and the at least one male pin 220 may connect with the female pin receptacle 140 of the battery pack 100. Once the vehicle 200, for example an electric scooter, is in operation, the battery pack 100 may require to be replaced periodically. During replacement, the battery pack 100 itself may be transported, stored, charged and managed as independent component. When bumps, drops, etc. occur during usage and operation, the female pin receptacle 140, due to its recessive design, is not easily contacted by the operator which may reduce the probability of damage. At the same time, by using the female pin receptacle 140, due to its recessive design, the risk of a short circuit by accident may be prevented since contact of the electrical component with other foreign objects, especially conductive materials such as metal, is avoided.

The female pin receptacle 140 may enable functions for battery charge, discharge and data communication. The female pin receptacle 140 may furthermore enable a high water resistance and/or waterproof level. The female pin receptacle 140 may additionally provide a facile handling due to the cooperative design with the at least one male pin 220.

The battery pack 100 may further comprise a top cover 145 forming a first waterproof seal at the top portion 125 of the elongated cell rack 105. The top cover 145 may be assembled or arranged on the top seal cover 120. The top cover 145 may be firmly fixed to the top seal cover 120 with fixation means. The fixation means may include at least one screw, nail, glue, rivet, or snap joint, or a combination thereof. The tubular battery case 115 and the top cover 145, together with the top seal cover 120 may form a closed cavity at the top portion 125 of the elongated cell rack 105.

The battery pack 100 may further comprise a bottom cover 155 arranged on the female pin receptacle 140. The bottom cover 155 may be firmly fixed to the bottom seal cover 130 with fixation means. The fixation means may include at least one screw, nail, glue, rivet, or snap joint, or a combination thereof. The female pin receptacle 140 may be positionable between the bottom cover 155 and the bottom seal cover 130. Hence, the female pin receptacle 140 may have a smaller rectangular surface than the bottom cover 155 and the bottom seal cover 130. The edges of the bottom cover 155 may have a skirt surrounding the female pin receptacle 140 and the bottom seal cover 130. In other words, the bottom cover 155 may surround the bottom portion 135, including the female pin receptacle 140 and the bottom seal cover 130, similar to a lid. The tubular battery case 115 together with the bottom cover 155 and the bottom seal cover 130 may form a semi-closed cavity at the bottom portion 135 of the elongated cell rack 105.

As mentioned, the bottom cover 155 may be engageable with the female pin receptacle 140 and the bottom seal cover 130. The engagement between the bottom cover 155, the female pin receptacle 140 and the bottom seal cover 130 may be a fixed engagement. It may furthermore be sufficiently tight. The tight engagement may be realized by an interference fit (e.g., a press fit or a friction fit). Additionally or alternatively, the tight engagement may be realized by use of an adhesive between the bottom cover 155, the female pin receptacle 140 and the bottom seal cover 130. Additionally or alternatively, the tight engagement may be realized by moulding the bottom cover 155, the female pin receptacle 140 and the bottom seal cover 130 to align in shape. For example, the bottom cover 155, the female pin receptacle 140 and the bottom seal cover 130 may be pieced together as an articulated mould, or by using piece-moulding. The tight engagement between the bottom cover 155, the female pin receptacle 140 and the bottom seal cover 130 may provide a water resistant and/or waterproof engagement.

The bottom portion 135 of the elongated cell rack 105 may provide access for insertion of at least one male pin 220. Hence, the bottom cover 155 may have an opening to allow for the at least one male pin 220 to pass through. The bottom cover 155 may thus render the bottom portion 135 to be engageable with the front end surface 230 to form a second waterproof seal.

As shown in FIG. 5B, the battery pack 100 may additionally comprise a sealing gasket ring 162. The sealing gasket ring 162 may be positionable on the bottom cover 155, for example, on an outer surface of the bottom cover 155. This sealing gasket ring 162 may form a third waterproof seal when the battery pack 100 is in the receptacle 210 of the vehicle 200. This third waterproof seal may be realized by the sealing gasket ring 162 being pressed between the front end surface 230 and the female pin receptacle 140. Due to the structural design, the second and third waterproof seal ensure a high waterproofing level of the battery pack 100. Hence, according to various embodiments, the battery pack 100 can realize IP67 dustproof and waterproof level by employing a second and a third waterproof seal at the disconnection area of the battery pack 100.

According to various embodiments, the battery pack 100 may further comprise a protection circuit module 180 (PCM). The PCM 180 may contain electrical control chips and data communication chips. The PCM 180 may be positionable on at least one of the elongated side surfaces of the top of the elongated cell rack 105. In particular, the PCM 180 may be welded on the elongated cell rack 105. The PCM 180 may be positionable in between the elongated cell rack 105 and the tubular battery case 115. The elongated cell rack 105 and the tubular battery case 115 may thus form a recess in which the PCM 180 may be disposed.

The battery pack 100 may further comprise a battery capacity indicator 150. The battery capacity indicator 150 may be positionable at the top portion 125 of the elongated cell rack 105. According to various embodiments, the battery capacity indicator 150 may be fixed to the top cover 145. Advantageously, this design may allow for a clear indication of the battery capacity integrated into the design of the battery pack 100. Hence, the design may improve convenience for operators to check the battery status of the battery pack 100 at any time, thereby improving work efficiency.

With reference to FIG. 5A, a battery capacity indicator 150 and a button 146 may be designed on the outside of the top cover 145. The button 146 may be made from any suitable material and may comprise, for example, silicon.

The battery capacity indicator 150 may include one or more, for example 4, light indicators 191. The light indicators 191 may be LED lights. The battery capacity indicator 150 may be electrically coupled to the PCM 180. The battery capacity indicator 150 may comprise a printed circuit board (PCB) on which the light indicators 191 are mounted. In one example, the light indicators 191 form a bar indicator. By checking the light indicators 191 of the battery capacity indicator 150, the remaining capacity of the one or more battery cells 110 may be clearly seen, which may improve convenience for the operator to judge whether the one or more battery cells 110 are charged or not. To save battery power, the battery capacity indicator 150 may be switched off and remain in standby mode. In case the operator needs to check the remaining battery capacity of the one or more battery cells 110, he may press the button 146 to switch on the battery capacity indicator 150. After a predetermined time period of displaying the battery capacity, for example, 5 seconds, the battery capacity indicator 150 may switch off again and remain in standby mode.

When charging the battery pack 100, the battery capacity indicator 150 may stay switched on continuously to inform the operator continuously of the status of battery power. When the battery pack 100 is fully charged, the light indicators 191 of the battery capacity indicator 150 may blink with a predetermined frequency, for example, 2 Hz. The operator may thus be informed that the battery pack 100 (i.e., all of the one or more battery cells 110) is fully charged.

According to various embodiments, the battery pack 100 may further comprise a first lubricating member 165 fixedly surrounding the bottom portion 135 of the elongated cell rack 105. The first lubricating member 165 may be in the form of a sleeve. According to various embodiments, the battery pack 100 may further comprise a second lubricating member 170 fixedly surrounding the top portion 125 of the elongated cell rack 105. The second lubricating member 170 may be in the form of a sleeve. With reference to FIG. 7, the first and the second lubricating members 165, 170 may be installed at the top portion 125 and the bottom portion 135 of the battery pack 100 to separate the battery pack 100 from the receptacle 210 in order to prevent friction and jamming between the battery pack 100 and the receptacle 210, and even short circuit caused by metal foreign objects. The sliding sleeves (or the lubricating members) 165, 170 may be made of self-lubricating and insulating materials, for example, nylon, which may not introduce metal foreign objects to contact with the receptacle 210 and may slide smoothly, so that the battery pack 100 may be replaced safely and conveniently.

According to various embodiments, the first and the second lubricating members 165, 170 may be configured to be durable so as to provide durable performance for frequent removal and insertion of the battery pack 100 by the operator. According to various embodiments, the first and the second lubricating members 165, 170 may be configured to be easily replaceable so as to allow easy maintenance from frequent usage and wear and tear.

According to various embodiments, the first and the second lubricating members 165, 170 may be wrapped at both ends of the battery pack 100, which may reduce the direct contact between the battery pack 100 and external objects. They may protect the battery pack 100 and improve the reliability of the battery pack 100.

According to various embodiments, the first and the second lubricating members 165, 170 and the battery pack 100 may be configured to be modular and have a universal configuration. Firstly, the first and the second lubricating members 165, 170 may be disassembled and replaced separately after being damaged, and the whole battery pack need not be replaced. Secondly, the first and the second lubricating members 165, 170 at the top portion 125 and the bottom portion 135 of the battery pack 100 may be interchanged to reduce the operation and maintenance costs for the same size parts. The first and the second lubricating members 165, 170 may be fastened to the top portion 125 and the bottom portion 135 of the battery pack 100. The fastening means may be removable to allow for interchange of the first and the second lubricating members 165, 170. Hence, the fastening means may comprise at least one screw, hook-and-loop fastener, button, or snap joint, or a combination thereof.

According to various embodiments, the battery pack 100 may be configured to include a pivotable pull-ring 175. According to various embodiments, the pivotable pull-ring 175 may be a mechanical structure which may allow the battery pack 100 to be taken out easily from the receptacle 210 of the vehicle 200 by using fingers instead of requiring tools. According to various embodiments, the pivotable pull-ring 175 may be fixed on the top portion 125 of the battery pack 100 in a permanent manner so as to be non-separable from the battery pack 100 at all times. According to various embodiments, the pivotable pull-ring 175 may be configured to be pivotable with respect to the top portion 125 such that the pivotable pull-ring 175 may be pivoted between a folded orientation wherein the pivotable pull-ring 175 is parallel to the top portion 125 of the battery pack 100 and a deployed orientation wherein the pivotable pull-ring 175 is perpendicular to a surface of the top portion 125 of the battery pack 100 which may allow a finger to be inserted into the pivotable pull-ring 175 for pulling the battery pack 100. According to various embodiments, the pivotable pull-ring 175 may be configured to be pivoted, at least, about a pivoting axis which is tangent to a point along a circumference of the pivotable pull-ring 175. According to various embodiments, the pivotable pull-ring 175 may be configured to pivot with a range of angle from 0° to 180° about the pivoting axis.

According to various embodiments, the battery pack 100 may further comprise one or more rubber seals 194. The one or more rubber seals 194 may be positioned on the bottom cover 155. The battery pack 100 may further comprise one or more silicon cushions 193. The one or more silicon cushions 193 may be positioned between the PCM 180 and the tubular battery case 115. The battery pack 100 may further comprise one or more labels 190. The one or more labels 190 may be positioned on an outer surface of the tubular battery case 115. The battery pack 100 may further comprise one or more light guide tubes 195. The one or more light guide tubes 195 may be positioned on an interior surface of the top cover 145.

According to various embodiments, there is provided a set 300 comprising the battery pack 100 as described above and the set 300 further comprising a connector comprising a front end surface 230 and at least one male pin 220 protruding from the front end surface 230. The at least one male pin 220 may be configured to cooperate with the female pin receptacle 140 to provide an electrical connection. The at least one male pin 220 may have a complementary shape to the female pin receptacle 140 of the battery pack 100. The female pin receptacle 140, together with the at least one male pin 220 of the vehicle 200, may be a plug-in type connection enabling easy and reliable insertion and removal of the battery pack 100 from a vehicle 200. The plug-in type connection may be a customized design wherein the pinhole sizes are designed such that the at least one male pin 220 may only be plugged into the female pin receptacle 140 with one specific direction.

The battery pack 100 of the set 300 may further comprise a bottom cover 155 arranged on the female pin receptacle 140, wherein the bottom cover 155 engages with the female pin receptacle 140 and the bottom seal cover 130 to render the bottom portion 135 of the elongated cell rack 105 accessible for insertion of the at least one male pin 220 and wherein the bottom cover 155 engages the bottom portion 135 to the at least one male pin 220 protruding from the front end surface 230 of the vehicle 200 such that the bottom cover 155 forms a second waterproof seal with the front end surface 230 from which the at least one male pin 220 protrudes.

The battery pack 100 of the set 300 may further comprise a sealing gasket ring 162 positionable on the bottom cover 155, to form a third waterproof seal with the front end surface 230 from which the at least one male pin 220 protrudes by pressure between the front end surface 230 and the female pin receptacle 140.

The second and third waterproof seal of the set 300 will now be described with reference to FIG. 5A and FIG. 5B.

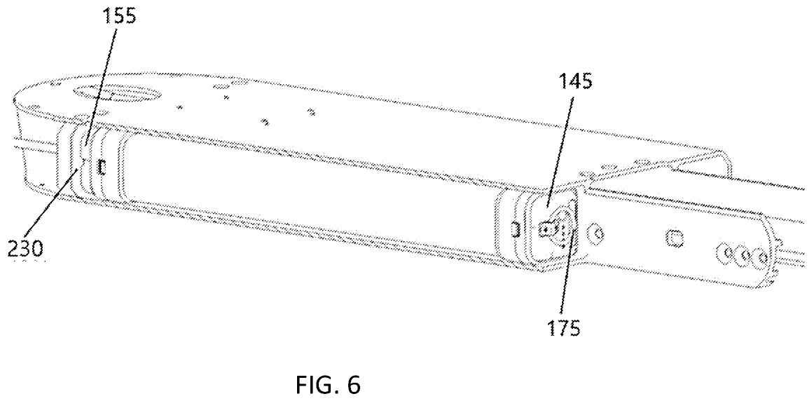

The female pin receptacle 140 of the battery pack 100 and the at least one male pin 220 of the receptacle 210 may be designed with double waterproof protection at the bottom portion 135 to prevent a battery short circuit if water went near the plug-in type connection. When the battery pack 100 is connected to the receptacle 210 of the vehicle 200, for example the electric scooter, the bottom portion 135 of the bottom cover 155 may press against the bottom portion 135 to seal, as shown in FIG. 6, which is termed herein the second waterproof seal. When the bottom end surface 135 of the bottom cover 155 is pressed tightly with the front end surface 230 of a receptacle 210 of the vehicle 200, the at least one male pin 220 may be inserted into the female pin receptacle 140. When the battery pack 100 is mounted on the vehicle 200, the sealing gasket ring 162, which may extend into the recessive part of the female pin receptacle 140, may be pressed between the front end surface 230 and the female pin receptacle 140 to form a third waterproof seal.

According to various embodiments, there is provided a vehicle 200 comprising the battery pack 100 according to embodiments above. The vehicle 200 may be an electric scooter. According to various embodiments, the electric scooter may be configured as a vehicle that is to be used by a user, has two or more wheels, is propelled or can be selectively propelled by an electric motor attached to the electric scooter. According to various embodiments, the electric scooter may be configured as a form of personal transportation for movement of user from one location to another location. The electric scooter may include a main body including a rider-support-platform structure and a steering column coupled to the rider-support-platform structure. According to various embodiments, the rider-support-platform structure may be configured to support a rider directly standing on top of the rider-support-platform structure. For example, the rider-support-platform structure may be a deck of an electric scooter configured for a rider to stand on. According to various embodiments, the rider-support-platform structure may be aligned horizontally with respect to a ground. According to various embodiments, the electric scooter may include a wheel arrangement supporting a main body. The wheel arrangement may include at least one front wheel and at least one rear wheel. According to various embodiments, the wheel arrangement may be supporting the main body in a manner such that the main body is elevated above the ground. Accordingly, only the at least one front wheel and the at least one rear wheel may be in contact with the ground. Hence, the electric scooter may be moved with respect to the ground via the rotation or turning of the at least one front wheel and the at least one rear wheel. According to various embodiments, the at least one front wheel may be configured to be steerable by a steering column. According to various embodiments, the steering column may be extending in an upward directions with respect to the rider-support-platform structure. According to various embodiments, the at least one front wheel may be coupled to the steering column. According to various embodiments, the steering column may include a front wheel fork which holds the at least one front wheel.

According to various embodiments, the vehicle 200 may comprise a receptacle 210. The receptacle 210 may be configured to receive the battery pack 100. The receptacle 210 may be a void within the vehicle 200. The receptacle 210 may further comprise a front end surface 230. The front end surface 230 may comprise a sealing gasket.

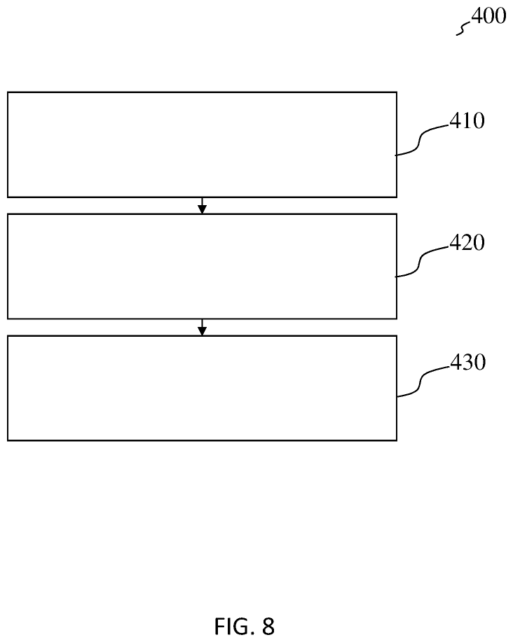

According to various embodiments, there is provided a method 400 of swapping a first battery pack 100A with a second battery pack 100B in a vehicle 200. Each of the first battery pack 100A and the second battery pack 100B may comprise features as described herein. As shown in FIG. 8, the method 400 may comprise a first step 410 of retrieving the first battery pack 100A from a receptacle 210 of the vehicle 200 by disconnecting the female pin receptacle 140 of the first battery pack 100A from at least one male pin 220 protruding from the front end surface 230 of the receptacle 210, a second step 420 of sliding the second battery pack 100B into the receptacle 210 of the vehicle 200, and a third step 430 of engaging the second battery pack 100B with the vehicle 200 by connecting the at least one male pin 220 protruding from the front end surface 230 of the receptacle 210 with a female pin receptacle 140 of the second battery pack 100B.

According to various embodiments, the method 400 of swapping a first battery pack 100A with a second battery pack 100B may be a “pull and insert” method. Since the method comprises a first battery pack 100A that is to be replaced with a second battery pack 100B, the first battery pack 100A may not be fully charged, while the second battery pack 100B may be fully charged.

According to various embodiments, there is provided a vehicle sharing system 500. The vehicle sharing system 500 may comprise the vehicle 200 according to embodiments above. According to various embodiments, the vehicle sharing system 500 may include a system setup for sharing the use of the vehicle 200, for example, electric scooter sharing. According to various embodiments, the sharing system may include a plurality of vehicles deployed in multiple locations for registered riders to easily rent it on site via network communication (e.g., via mobile phone network communication by using a mobile phone application, etc.) so as to use the vehicle 200 as a mode of transportation. The vehicle sharing system 500 may further comprise a battery charging station 510 configured to charge a battery pack 100 removed from the vehicle 200.

Embodiments described in the context of one of the enclosure assemblies, vehicles, or methods are analogously valid for the other enclosure assemblies, vehicles, or methods. Similarly, embodiments described in the context of an enclosure assembly are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A battery pack for mounting on a vehicle comprising:
an elongated cell rack comprising two or more battery cells arranged therein, wherein two adjacent battery cells of the two or more battery cells are spaced apart by a distance selected between about 1.0 mm to about 5.0 mm;
a tubular battery case at least partially surrounding the elongated cell rack;
a top seal cover sealing a top portion of the elongated cell rack;
a bottom seal cover arranged at a bottom portion of the elongated cell rack; and
a female pin receptacle arranged on the bottom seal cover at the bottom portion of the elongated cell rack.

2. The battery pack of claim 1, further comprising a top cover forming a first waterproof seal at the top portion of the elongated cell rack.

3. The battery pack of claim 1, further comprising a bottom cover arranged on the female pin receptacle,
wherein the bottom cover is engageable with the female pin receptacle and the bottom seal cover to render the bottom portion of the elongated cell rack accessible for insertion of at least one male pin.

4. The battery pack of claim 3, further comprising a sealing gasket ring positionable on the bottom cover.

5. The battery pack of any one of claim 1, further comprising a battery capacity indicator.

6. The battery pack of claim 5, wherein the battery capacity indicator is positionable at the top portion of the elongated cell rack.

7. The battery pack of claim 1, further comprising a first lubricating member fixedly surrounding the bottom portion of the elongated cell rack.

8. The battery pack of claim 1, further comprising a second lubricating member fixedly surrounding the top portion of the elongated cell rack.

9. The battery pack of claim 8, wherein one or each of the first lubricating member and the second lubricating member is in the form of a sleeve and is made of self-lubricating material.

10. The battery pack of claim 1, further comprising a pivotable pull-ring at the top portion of the elongated cell rack.

11. The battery pack of claim 1, wherein the tubular battery case comprises aluminum.

12. The battery pack of claim 1, wherein the tubular battery case comprises or consists of a one-piece tubular segment.

13. A set comprising a battery pack for mounting on a vehicle, the set comprising the battery pack comprising:
an elongated cell rack comprising two or more battery cells arranged therein, wherein two adjacent battery cells of the two or more battery cells are spaced apart by a distance selected between about 1.0 mm to about 5.0 mm;
a tubular battery case at least partially surrounding the elongated cell rack;
a top seal cover sealing a top portion of the elongated cell rack;
a bottom seal cover arranged at a bottom portion of the elongated cell rack; and
a female pin receptacle arranged on the bottom seal cover at the bottom portion of the elongated cell rack,
and the set further comprising:
a connector comprising a front end surface and at least one male pin protruding from the front end surface, the at least one male pin being configured to cooperate with the female pin receptacle to provide an electrical connection, wherein the at least one male pin has a complementary shape to the female pin receptacle of the battery pack.

14. The set of claim 13, wherein the battery pack further comprises a bottom cover arranged on the female pin receptacle,
wherein the bottom cover is engageable with the female pin receptacle and the bottom seal cover to render the bottom portion of the elongated cell rack accessible for insertion of the at least one male pin and wherein the bottom cover renders the bottom portion to be engageable with the front end surface to form a second waterproof seal.

15. The set of claim 14, wherein the battery pack further comprises a sealing gasket ring positionable on the bottom cover, to form a third waterproof seal with the front end surface from which the at least one male pin protrudes by being pressed between the front end surface and the female pin receptacle.

16. (canceled)

17. (canceled)

18. (canceled)

19. (canceled)

20. A method of swapping a first battery pack with a second battery pack in a vehicle, each of the first battery pack and the second battery pack comprising:
an elongated cell rack comprising two or more battery cells arranged therein, wherein two adjacent battery cells of the two or more battery cells are spaced apart by a distance selected between about 1.0 mm to about 5.0 mm;
a tubular battery case at least partially surrounding the elongated cell rack;
a top seal cover sealing a top portion of the elongated cell rack;
a bottom seal cover arranged at a bottom portion of the elongated cell rack; and
a female pin receptacle arranged on the bottom seal cover at the bottom portion of the elongated cell rack,
wherein the method comprises:
a first step of retrieving the first battery pack from a receptacle of the vehicle by disconnecting the female pin receptacle of the first battery pack from at least one male pin protruding from a front end surface of the receptacle,
a second step of sliding the second battery pack into the receptacle of the vehicle, and
a third step of engaging the second battery pack with the vehicle by connecting the at least one male pin protruding from the front end surface of the receptacle with a female pin receptacle of the second battery pack.

21. (canceled)

22. (canceled)
